(19) United States
(12) Patent Application Publication
(10) Pub. No.: US 2014/0223817 A1
(43) Pub. Date: Aug. 14, 2014

(54) Apparatus and Method for Producing Feed

(71) Applicant: Stan L. Simon, Kerkhoven, MN (US)

(72) Inventor: Stan L. Simon, Kerkhoven, MN (US)

(21) Appl. No.: 13/764,286

(22) Filed: Feb. 11, 2013

(51) Int. Cl. A01G 31/02

(52) U.S. Cl. CPC A01G 31/02
USPC 47/59 R

(57) ABSTRACT

An apparatus and method for producing an aquatically grown feed include at least one length of conduit having therein stratified water and gas. The water is periodically circulated through the conduit and the aquatic feed grows on the surface of the water. Downstream of the conduit, the aquatic feed and water are separated via a screen. The water is recirculated and the aquatic feed is harvested. The gas within the conduit is pressurized above atmospheric, thereby creating a hyperbaric growing environment for the aquatic feed. Further, carbon dioxide and/or ammonia can be injected into the gas while fertilizer and/or pH correction solutions can be injected into the water. A programmable control system can be used to regulate components of the apparatus.

### CROSS-REFERENCE TO RELATED APPLICATIONS

None

### STATEMENT REGARDING FEDERALLY SPONSORED RESEARCH

Not Applicable

### BACKGROUND OF THE INVENTION

Modern agriculture presents a combination of traditional challenges and contemporary considerations. Extreme weather events, economic stresses, fluctuating product prices, high input costs, consumer quality demands, growing population, loss of farmland for urban development, political unrest, and other social and monetary phenomena have heightened concerns about worldwide food supply. In the United States, many of the aforementioned factors have combined, leading to a significant rise in arable land prices, debate about proper usage of food crops in energy production, and predictions of further commodity price increases.

Various apparatus have been designed to produce livestock feed using less space and in year-round fashion. Nonetheless, there remains a need for a method and apparatus to produce livestock feed in an efficient manner, utilizing limited space.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

A method for producing feed comprises providing at least one length of conduit, an inlet water valve, an outlet water valve, a sump tank having thereover a removable screen, an aquatic feed organism, and a water pump. The conduit defines an input side and an output side and has therein stratified water and gas. The inlet water valve is disposed upstream of the input side and the outlet water valve is disposed downstream of the output side. The sump tank is located downstream of the outlet water valve. The aquatic feed organism is disposed upon the surface of the water within the conduit.

The method further comprises growing the aquatic feed organism upon the surface of the water within the length of conduit and periodically circulating the water through the conduit and outlet water valve with the water pump. The method further comprises separating the aquatic feed organism from the water via the removable screen and periodically circulating the water from the sump tank through the inlet water valve with the water pump.

The method may further comprise injecting carbon dioxide and/or ammonia into the gas stratified in the conduit; the gas within the conduit is at a pressure above standard atmospheric pressure.

An apparatus for producing feed comprises at least one length of conduit, an inlet water valve, an outlet water valve, a sump tank having thereover a removable screen, an aquatic feed organism, and a water pump. The conduit defines an input side and an output side. When in use, the conduit has therein stratified water and gas. The inlet water valve is disposed upstream of the input side and the outlet water valve is disposed downstream of the output side. The sump tank is located downstream of the outlet water valve. The sump pump operates to recirculate water from the output side to the input side. The aquatic feed organism is disposed upon the surface of the water within the conduit.

The apparatus may, optionally, further comprise a first tank for storing compressed carbon dioxide and/or a second tank for storing compressed ammonia, the first and/or second tanks may be connected to the conduit via gas lines.

Additionally, the apparatus may, optionally, comprise a fertilizer tank and/or a pH correction tank. The fertilizer tank has therein a liquid fertilizer solution and the pH correction tank has therein a pH correction solution. The liquid fertilizer and the pH correction solutions are injectable into the conduit to fertilize the aquatic feed organism and adjust pH, respectively.

In some embodiments, an apparatus for producing feed comprises a water pump and at least one length of conduit. The conduit has an input side and an output side. Disposed within the conduit are water and gas. Additionally, the apparatus has an inlet water valve disposed upstream of the input side and an outlet water valve disposed downstream of the output side. The apparatus further comprises a sump tank downstream of the outlet water valve. The sump tank has thereover a removable screen. The water pump is configured to circulate the water from the sump tank through the inlet water valve. The water pump is further configured to periodically circulate the water through the conduit and outlet water valve. The apparatus has an aquatic feed organism disposed upon the surface of the water within the conduit. In addition, the apparatus comprises a gas supply. The gas supply is in gaseous communication with the conduit.

In some embodiments, an apparatus for producing feed comprises at least one length of conduit. The conduit has an input side and an output side. Disposed within the conduit are water and gas. Additionally, the apparatus has an inlet water valve disposed upstream of the input side and an outlet water valve disposed downstream of the output side. The apparatus further comprises a sump tank downstream of the outlet water valve. The sump tank has thereover a removable screen. Further, the apparatus comprises a water pump and an aquatic feed organism disposed upon the surface of the water within the conduit. The apparatus also includes a pH correction tank, in fluid communication with the conduit, and a pressure tank, in gaseous communication with the conduit. The pH correction tank has therein a basic solution and the pressure tank has therein a compressed gas.

In some embodiments, the apparatus is used in combination with a livestock building. At least a portion of the apparatus is disposed within the livestock building.

In some embodiments, the livestock building includes a manure pit and leachate sump. The leachate sump is in fluid communication with the apparatus.

### BRIEF DESCRIPTION OF THE SEVERAL VIEWS OF THE DRAWING(S)

FIG. 1 shows a side view of the apparatus of FIG. 2.

FIG. 2 shows a schematic view of an embodiment of an apparatus for producing feed within a building.

### DETAILED DESCRIPTION OF THE INVENTION

While this invention may be embodied in many different forms, there are described herein specific embodiments. This description is an exemplification of the principles of the invention and is not intended to limit it to the particular embodiments illustrated.

For the purposes of this disclosure, like reference numerals in the figures shall refer to like features unless otherwise indicated.

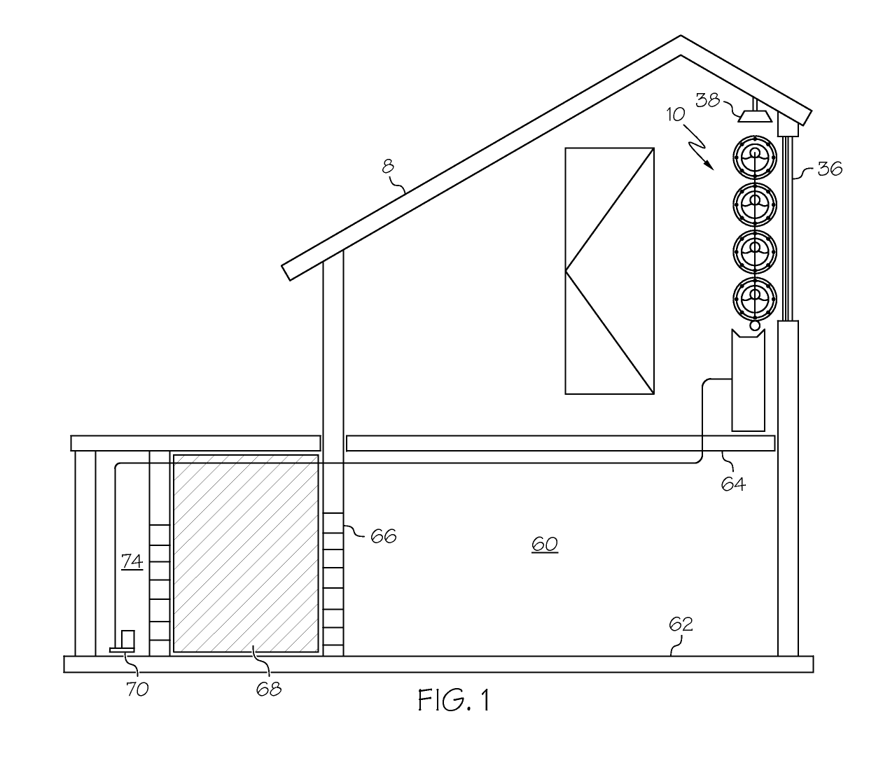

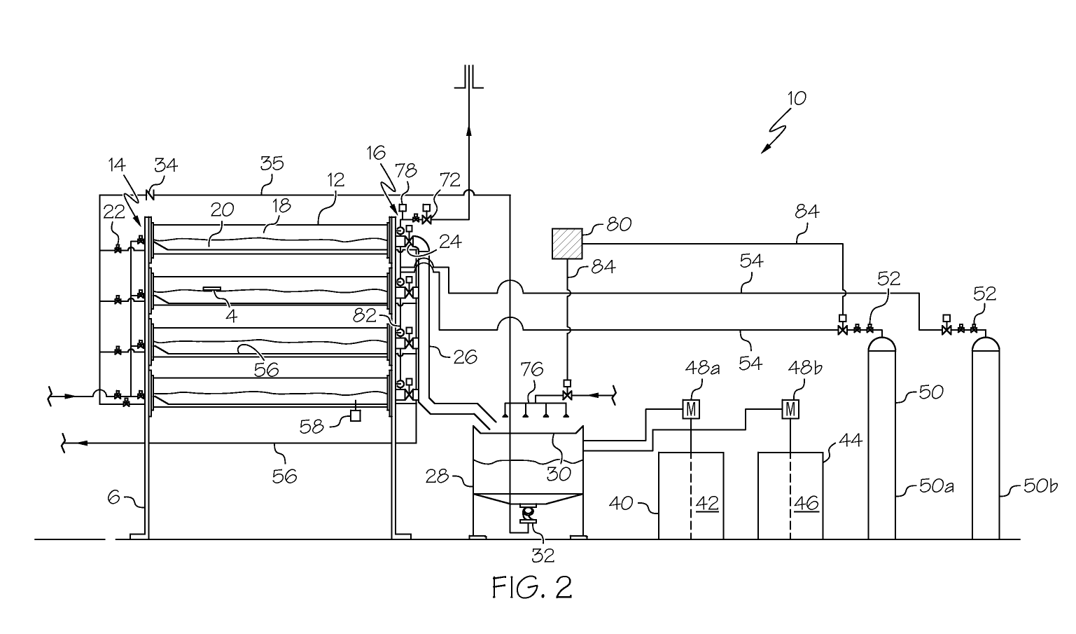

As shown in FIGS. 1 and 2, an apparatus 10 for producing feed is illustrated. More specifically, the apparatus 10 is configured to produce feed grown in an aquatic environment.

The apparatus 10 can be located within a building 8 or other structure. The apparatus 10 comprises one or more lengths of conduit 12. The conduit 12 has an input side 14 and an output side 16. Water 20 and gas 18 are disposed within the conduit 12 and provide an environment for growing feed. The gas 18 is disposed above the surface of the water 20. The water 20 is circulated through the conduit 12, entering the conduit 12 at the input side 14 and exiting at the output side 16.

Upstream of the input side 14 is an inlet water valve 22 which regulates the water flow into the conduit 12. In some embodiments, the inlet water valve 22 comprises a balancing valve, which balances the water flow between multiple conduits 12, for example where more than one conduit 12 is employed.

Downstream of the output side 16 of the conduit 12 is a drain pipe 26. Water flows out of the conduit 12 through the drain pipe 26. In some embodiments, the water 20 exits though an outlet water valve 24. In some embodiments, the outlet water valve 24 comprises a butterfly valve. Upon opening the outlet water valve 24, water flows out of the drain pipe 26 and falls into sump tank 28. The sump tank 28 has a removable screen 30 thereover.

In order to recirculate the water through the system, the sump tank 28 has a pump 32. The pump 32 pumps water 20 from the sump tank 28 through the return pipe 35 and, in some embodiments, the check valve 34. The water 20 then returns to the inlet water valve 22. Further, the pump 32 can be run intermittently in order to periodically circulate the water 20. This can be done, for example, via a programmable control system or timer.

In some embodiments, the apparatus 10 comprises a number of conduits 12. The conduits 12 can be stacked vertically, for example as shown in FIG. 1, and/or arranged in a horizontal fashion, or any other suitable configuration. The conduit 12 can be held in place via a support 6, for example a rack system. In some embodiments, the support 6 can comprise a pre-drilled assembly that is modular.

In some embodiments, the apparatus 10 is used to grow aquatic feed 4, for example duckweed (Lemna). Another variety of aquatic feed 4 that can be grown in apparatus 10 is Azolla, which is capable of nitrogen fixation. Duckweed can be used to feed livestock, for example, poultry, hogs, fish, and other suitable animals. In some embodiments, the aquatic feed 4 is Lemna. As a feedstock, Duckweed has advantages over more traditional feeds. In particular, it is high in protein and can be grown quickly in a suitable environment, such as disclosed herein. Further, Lemna has a small leaf size, making it easy to handle. Additionally, it can replace soy meal in corn based poultry rations. Under proper growing conditions, species of Lemna plant reportedly double in size within a 24 hour period of time. Finally, amino acid profiles for Lemna reveal that it has a protein structure more similar to meat than traditional plant feedstock. This, in turn, translates into rapid muscle grown and weight gain in livestock.

In some embodiments, the apparatus 10 uses natural light, for example via window 36. In some embodiments, the apparatus 10 can be used in a greenhouse or other suitable environment. Further, the apparatus 10 can make use of an artificial lighting source 38 in order to promote growth of the aquatic feed material. In some embodiments, the artificial lighting source 38 includes light emitting diodes (LEDs) providing the desired wavelength(s) of light. Plants generally respond favorably to wavelengths of light in the red and blue spectrums. LEDs can be selected to emit light in these spectrums. Specifically, in some embodiments, the lighting source 38 can emit wavelengths of light from 425 nanometers (nm) to 475 nm and 625 nm to 675 nm. And, some particular wavelengths are: 370 nm, 439 nm, 469 nm, 642 nm, 660 nm, 667 nm, and 730 nm. LEDs of the aforementioned wavelengths can be selected to provide a grid of LEDs, for example, in the desired quantity from one or more of the aforementioned spectrums. Further, the skilled artisan will appreciate that the desired wavelength(s), and combinations of wavelengths, can vary depending upon the selected plant species within the conduit 12. Finally, in some embodiments, the artificial lighting source 38 can also be located within the conduit 12.

In some embodiments, the conduit 12 can be made of a transparent material, such that the aquatic feed 4 can use an exterior light source for photosynthesis. In some embodiments, for example where photosensitive animals are in close proximity to the apparatus 10 and the apparatus' 10 light source would interfere with the animals' lighting schedule, the conduit 12 can be made of an opaque material having a lighting source 38 disposed within the conduit 12.

In some embodiments, the apparatus 10 further includes a fertilizer tank 40. The fertilizer tank 40 can be used to store, for example, liquid fertilizer 42 that is injected into the water 20. The fertilizer tank 40 has an injector pump 48a to inject the contents of the fertilizer tank 40 into the conduit 12. The injector pump 48a can be on a timer, for example, in order to periodically inject fertilizer.

Further, the apparatus 10 can include a pH correction tank 44 holding a suitable pH correction solution 46 to correct the pH in the water 20. In some embodiments, a weak solution of potassium hydroxide is held in the pH correction tank 44. The pH correction tank 44 has an injector pump 48b to inject the contents of the pH correction tank 44 into the conduit 12. The pH correction solution 46 can be administered, for example, via a timer or programmable control system 80. In some embodiments, the water 20 has therein minerals and other components. A non-exhaustive list of such minerals and components is shown below in Table 1. Also shown is a range of concentration. The skilled artisan will appreciate that the concentrations can be varied depending upon the species of aquatic feed 4 grown. Additionally, nitrate concentration, in particular, may need to be held below approximately 100 ppm due to risk to the animal (e.g., ruminants) consuming the aquatic feed 4. Where a higher concentration of nitrates is desired in order to promote plant growth, the aquatic feed 4 can undergo a fresh water rinse prior to ingestion by an animal. Therefore, in some embodiments, the apparatus 10 comprises one or more spray heads 76; the spray head 76 rinses the aquatic feed 4, for example, after it has exited the conduit 12. In some embodiments, the spray head 76 rinses the aquatic feed 4 as the aquatic feed 4 exits the drain pipe 26 and, in some embodiments, once the aquatic feed 4 has been deposited on the removable screen 30.

TABLE 1

| | | range |
|---|---|---|
| Element | Ionic forms absorbed by plants | (ppm) |
| Nitrogen | Nitrate (NO3⁻) | 100-250 |
| | Ammonium (NH₄⁺) | |
| Phosphorus | H₂PO₄⁻, PO₄³⁻, | 30-50 |
| | HPO₄²⁻ | |
| Potassium | Potassium (K⁺) | 100-300 |
| Calcium | Calcium (Ca²⁺) | 80-140 |
| Magnesium | Magnesium (Mg²⁺) | 30-70 |
| Sulfur | Sulfate (SO₄²⁻) | 50-120 |
| Iron | Fe²⁺, Fe³⁺ | 1.0-3.0 |
| Copper | Copper (Cu²⁺) | 0.08-0.2 |
| Manganese | Manganese (Mn²⁺) | 0.5-1.0 |
| Zinc | Zinc (Zn²⁺) | 0.3-0.6 |
| Molybdenum | Molybdate (MoO₄²⁻) | 0.04-0.08 |
| Boron | BO₃²⁻, B₄O₇²⁻ | 0.2-0.5 |
| Chloride | Chloride (Cl⁻) | <75 |
| Sodium | Sodium (Na⁺) | <50 |

In addition to the foregoing, the apparatus 10 can include one or more tanks 50 for compressed gas. In some embodiments, a first tank 50a for compressed gas holds compressed carbon dioxide, CO₂. The CO₂ is injected into the gas 18 within the conduit 12. Injection of the CO₂ can increase the growth rate of the aquatic feed 4, thereby leading to higher productivity of the apparatus 10.

Some embodiments of apparatus 10 include a second tank 50b for compressed gas. The second tank 50b for compressed gas can include, for example, compressed ammonia. The ammonia can be added to the gas 18 within the conduit 12 to encourage growth of the aquatic feed 4. The first and second tanks 50a, 50b can also be referred to as pressure tanks

Attached to the tanks 50a, 50b for compressed gas are pressure regulators 52. The pressure regulators 52 regulate the pressure of gas within the gas lines 54. Moreover, the pressure regulators 52 can include a full-lock-up high pressure regulator, solenoid valve, and a low pressure regulator. The pressure regulators 52 reduce the pressure entering the conduit 12 from the tanks 50a, 50b. Further, a full-lock-up high pressure regulator does not allow the upstream gas pressure to creep by when the flow of gas is not desired, thus protecting a low pressure regulator and the conduit 12 from overpressure.

When the apparatus 10 is located within a building 8, it will be appreciated that not all of the components need necessarily be located within the building. For example, the tanks 50 can be located exterior to the building 8.

In some embodiments, the apparatus 10 further includes a tube 56. A heating or cooling fluid can flow through the tube 56 in order to heat or cool the water 20 within the conduit 12. This may be incorporated into the apparatus 10, for example, in order to keep the water 20 within a desired temperature range, in order to encourage growth of the aquatic feed 4. In some embodiments, the tube 56 is disposed in the water 20, within the conduit 12, and acts as a heat exchanger. In order to regulate the temperature of the water 20, a thermostat 58 can be used. Moreover, the fluid within the tube 56 can be any suitable fluid, for example, water, which can be heated or cooled via a hydronic heating source such as a boiler (not shown).

With further regard to FIG. 1, some embodiments of the apparatus 10 recycle animal waste. In particular, some embodiments of the apparatus 10 can be located within a portion of a barn or chicken coop, for example, wherein animal manure is used as a fertilizer for growing aquatic feed 4. A suitable example of such a facility is shown in FIG. 1.

In some embodiments, the building 8 is located above a manure pit 60, for example a liquid pit. The manure pit 60 has a suitable manure pit floor 62, for example made of concrete; the building 8 has a slotted floor 64 that serves as the ceiling, or a portion thereof, through which the manure enters the manure pit 60. The manure pit 60 further comprises weepage screens 66 and a media filter 68, for example comprising sand, through which the manure leaches. The leachate collects in a nutrient well 74 and is then pumped back into the apparatus 10 via leachate sump 70 to be used as fertilizer. In some embodiments, the leachate is pumped into the sump tank 28 where it mixes with the water 20.

In some embodiments, the media filter 68 comprises a layer of fine sand, for example 10 feet in thickness. The sand restricts the flow of particulates, bacteria, and unwanted pathogens while allowing for the passage of water soluble nutrients to pass through the media filter 68.

Operation of an embodiment of the apparatus 10 will now be discussed. Water 20 fills the conduits 12 such that the water level is approximately one-half the cross-sectional height of the conduit. The minimum water level within the conduit 12 may be maintained by a weir on the output side 16. In some embodiments, the water 20 takes up approximately half the total volume of the conduit, while gas 18 takes up the remainder. When filling the conduit 12, the outlet water valve 24 can be kept closed in order to pressurize the conduit 12. The air pressure can be regulated by bleeding off some of the gas 18 during the fill cycle.

On the surface of the water 20 is an aquatic feed 4. In some embodiments, the aquatic feed 4 is Lemna. While in the conduit 12, the aquatic feed 4 grows and multiplies. Then, some of the aquatic feed 4 and some of the water 20 within the conduit 12 exits the conduit 12 through the output side 16. To circulate the water 20, pump 32 pumps water 20 from the sump tank 28 through check valve 34 into the input side 14 of conduit 12. Further, in some embodiments, the outlet water valve 24 is closed prior to turning off the pump 32. Because the conduit is otherwise sealed, the incoming water 20 increases the pressure of the gas 18 within the conduit 12 above standard atmospheric pressure, thereby providing a hyperbaric condition within the conduit 12. A pressure sensor 78 may sense the pressure within the conduit 12 and, when a predetermined pressure is reached, the pump 32 is automatically turned off. In some embodiments, the pressure sensor 78 is located on a gas header 82. It will be appreciated that the pressure in the conduit 12 can be raised without the use of an air compressor or similar apparatus. Moreover, the increased pressure within the conduit 12 helps to expel the aquatic feed 4 from the conduit 12 during discharge of the water 20 from the conduit through output side 16. In some embodiments, the air pressure within the conduit 12 can be regulated via an air valve 72 that opens to relieve excess pressure caused by the operation of the pump 32.

Upon exiting the conduit 12 via output side 16, the water 20 is discharged into the sump tank 28, while the aquatic feed 4 is separated from the water 20 with the removable screen 30 which, in some embodiments, is placed above the water level in the sump tank 28. The aquatic feed 4 can then be gathered for use at a later time or eaten directly, for example where the apparatus 10 is located within a barn or chicken coop. One such example could involve chickens eating the aquatic feed 4 off of the removable screen 30.

As mentioned above, in order to increase the production rate of the aquatic feed 4, some embodiments include a CO₂ injection system. The CO₂ is stored, for example, in the first tank 50a for compressed gas. In contrast to known aquatic plant growth systems that inject CO₂ into the water and suffer from increased acidity in the water, however, the CO₂ injection system herein disclosed injects CO₂ into the gas 18 above the surface of the water 20. This reduces acidification of the water 20. Additionally, to further offset any change in pH due to CO₂ injection, some embodiments include a pH buffer, as discussed in greater detail below.

Research has shown that an atmosphere containing 2000 ppm CO₂ can increase plant growth by five times, when accompanied by other requisite nutrients. Therefore, increasing the concentration of CO₂ is believed to dramatically increase production. Further, the CO₂ can be used to raise the pressure within the conduit 12 to above atmospheric in order to create a pressurized environment.

In some embodiments, the absolute pressure within the conduit 12 is approximately 2 atmospheres and the CO₂ concentration is approximately 2000 ppm. Concentration of the ammonia gas is regulated to prevent the nitrogen concentration in the water 20 from becoming too high. Moreover, due to the hydrophilic nature of ammonia, it may be absorbed into the water where it forms nitrite and nitrate.

In addition to injecting CO₂, some embodiments include an ammonia injection system. The ammonia is stored, for example, in the second tank 50b and is injected into the gas 18 above the surface of the water 20. Use of ammonia is useful for increasing the grown rate of Lemna because Lemna is able to utilize ammonia directly, without the ammonia being converted first into nitrite. The ammonia gas can also be used to raise the pressure within the conduit 12 to above atmospheric in order to create a pressurized environment. The ammonia can also be injected into the water 20.

Some embodiments of the apparatus 10 include a pH buffer. As noted above, the pH buffer can be used to offset low pH due to CO₂ injection. The pH buffer can comprise a pH correction solution 46, for example a basic solution. In some embodiments, the basic solution includes potassium hydroxide. In some embodiments, the pH correction solution 46 is injected into the sump tank 28, where it is subsequently pumped, along with the water 20, into the conduit 12 via pump 32.

Liquid fertilizer 42 can also be injected, for example, into the sump tank 28 for circulation into the conduit 12. The liquid fertilizer 42 can include potassium, phosphorus, dipotassium phosphate, trace elements, and other compounds, including, but not limited to:
MgSO₄*7 H₂d (Hydrated Magnesium Sulfate), H₃BO₃ (Boric Acid), KH₂PO₄ (Monopotassium Phosphate), MnCl₂*4H₂O (Manganous Chloride), KNO₃ (Potassium Nitrate), CuCl₂*2H₂O (Cupric Chloride), K₂SO₄ (Potassium Sulfate), MoO₃ (Molybdenum trioxide), Ca(NO₃)₂ (Calcium Nitrate), ZnSO₄*7H₂O (Hydrated Zinc Sulfate), and Fe 330 (Chelated iron).

Components of the apparatus 10 can be controlled via programmable control system 80, which is configured and wired, for example via wires 84, to open and close valves, circulate water via the water pump, inject fertilizer and/or gas, and carry out functions of the apparatus 10.

As the aquatic feed 4 grows within the conduit 12, oxygen is released and the concentration of oxygen builds. An increase in the concentration of oxygen can reduce plant growth. In order to offset the increased concentration of oxygen, an oxygen scavenging solution may be injected to reduce the concentration of oxygen gas. The oxygen scavenger can be mixed with the liquid fertilizer 42 within the fertilizer tank 40 in a predetermined ratio or it can be disposed in a separate injection tank (not shown). Examples of oxygen scavengers include a potassium sulfite solution and/or ammonium polyphosphate, which can also double as a phosphate source for plant growth, sodium nitrite, potassium nitrite, and carbohydrazide. Nitrites can also be used as a fertilizer source. Further, use of nitrites may require a catalyst, for example erythorbate.

In addition to the foregoing, the apparatus 10 can also be used for, or in combination with, wastewater treatment, genetic research, and carbon sequestration.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A method comprising:
providing:
at least one length of conduit, the conduit having an input side and an output side and having therein stratified water and gas;
an inlet water valve disposed upstream of the input side and an outlet water valve disposed downstream of the output side;
a sump tank downstream of the outlet water valve, the sump tank having thereover a removable screen;
a water pump; and
an aquatic feed organism disposed upon the surface of the water within the conduit;
growing the aquatic feed organism upon the surface of the water within the length of conduit;
periodically circulating the water through the conduit and outlet water valve with the water pump;
separating the aquatic feed organism from the water via the removable screen;
periodically circulating the water from the sump tank through the inlet water valve with the water pump; and
injecting carbon dioxide and/or ammonia into the gas stratified in the conduit, wherein the gas within the conduit is at a pressure above standard atmospheric pressure.

2. The method of claim 1, wherein the aquatic feed organism is Azolla or Lemna.

3. The method of claim 1 further comprising providing an artificial lighting source to encourage growth in the aquatic feed material.

4. The method of claim 1 further comprising regulating the temperature of the water.

5. The method of claim 1 further comprising feeding the feed organism to livestock.

6. The method of claim 1 further comprising providing a programmable control system, the programmable control system communicating with the water pump and at least one of the inlet and outlet water valves.

7. The method of claim 1 further comprising rinsing the aquatic feed organism.

8. The method of claim 1 further comprising regulating the pH of the water.

9. The method of claim 8, wherein regulating the pH of the water comprises injecting a basic solution into the water.

10. The method of claim 9, wherein the basic solution comprises potassium hydroxide.

11. The method of claim 1 further comprising injecting an oxygen scavenging solution into the water.

12. The method of claim 11, wherein the oxygen scavenging solution is selected from the group consisting of potassium sulfite, ammonium polyphosphate, sodium nitrite, potassium nitrite, and combinations thereof

13. The method of claim 1 further comprising injecting a liquid fertilizer into the water.

14. The method of claim 13, wherein the liquid fertilizer comprises dipotassium phosphate.

15. An apparatus comprising:
a water pump;
at least one length of conduit, the conduit having an input side and an output side and having therein water and gas;
an inlet water valve disposed upstream of the input side and an outlet water valve disposed downstream of the output side;
a sump tank downstream of the outlet water valve, the sump tank having thereover a removable screen, the water pump configured to circulate the water from the sump tank through the inlet water valve;
an aquatic feed organism disposed upon the surface of the water within the conduit;
the water pump further configured to periodically circulate the water through the conduit and outlet water valve; and
a gas supply in gaseous communication with the conduit.

16. The apparatus of claim 15, wherein the gas supply includes gaseous carbon dioxide and/or ammonia.

17. The apparatus of claim 15, wherein the pressure within the conduit is above standard atmospheric pressure.

18. An apparatus comprising:
at least one length of conduit, the conduit having an input side and an output side and having therein stratified water and gas;
an inlet water valve disposed upstream of the input side and an outlet water valve disposed downstream of the output side;
a sump tank downstream of the outlet water valve, the sump tank having thereover a removable screen;
a water pump;
an aquatic feed organism disposed upon the surface of the water within the conduit;
a pH correction tank having therein a basic solution, the pH correction tank in fluid communication with the conduit; and
a pressure tank having therein compressed gas, the pressure tank being in gaseous communication with the conduit.

19. The apparatus of claim 18, wherein the compressed gas includes carbon dioxide.

20. The apparatus of claim 18 in combination with a livestock building, at least a portion of the apparatus disposed within the livestock building.
